(19) United States
(12) Patent Application Publication
(10) Pub. No.: US 2009/0077275 A1
(43) Pub. Date: Mar. 19, 2009

(54) Multiple I/O interfacing system for a storage device and communicating method for the same

(76) Inventor: Chaoyang Zhang, Chang Chun City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/081,039

(22) Filed: Apr. 10, 2008

Related U.S. Application Data
(60) Provisional application No. 60/973,556, filed on Sep. 19, 2007.

(51) Int. Cl. G06F 3/00

(52) U.S. Cl. 710/38

(57) ABSTRACT

A multiple I/O interfacing system for a storage device and communicating method for the same are disclosed. The present invention is particularly embodied in the storage product of a computer system, where it implements a high-reliability connection between the processing units of at least two input/output cards. The preferred embodiment of the multiple I/O communicating method includes a first step of periodically broadcasting commands and data packets by the processing units for each I/O card. Simultaneously the processing units determine if any communication path fails. If there is no failed path, a first path is preferably being a master path, and a second path is being a secondary path. If one of the paths fails, the other one will be the communication path since a redundant mechanism activates. Next, the failure message will be sent to system unit the failure is eliminated.

### REFERENCE TO RELATED APPLICATION

This Application is based on Provisional Patent Application Ser. No. 60/973,556, filed 19 Sep. 2007, currently pending.

### BACKGROUND OF THE INVENTION

1. Field of the Invention

The present invention relates to a multiple I/O interfacing system for a storage device and communicating method for the same; in particular, it relates to a connection interface system for two I/O control cards between storage devices interfaces.

2. Description of Related Art

The general computer architecture includes one or more processors with memory connected therebetween, and further connects to multiple peripheral devices through the operations of various input/output (I/O) interfaces, in which the communications between a computer host and various peripheral devices are based on specific message formats, interchanging messages by using various input/output interfaces.

In storage product design, it is common to use an application environment having multiple input/output control cards, and usually required to implement communications between two or more I/O control cards. Referring to FIG. 1 of prior art, wherein a diagram of embodiment for a storage device using multiple I/O control cards is shown. Herein, in order to eliminate the bottleneck during data transmission and also facilitating access control among data queues, prior art enables, through a Small Computer System Interface (SCSI) bus 118, the processor 110 to communicate with multiple storage devices, as shown in the diagram, each of them includes an SCSI device controller 124 and a storage media 122, wherein each storage device communicates with each other via the SCSI bus 118 by means of a plurality of independent I/O ports, further connected to the processor 110 by the SCSI adapter 114. Thereafter, the processor 110 can make each storage device work efficiently through each SCSI device controller 124.

Using the above-mentioned multiple I/O interface system architecture, a data process system architecture as illustrated in FIG. 2 can be generated, wherein a data process system of a storage subsystem having multiple I/O interfaces is shown, with independent communication paths existing between each I/O interface and storage device. The computer host 210 shown in the diagram includes an application 212, an operating system 214 and an input/output (I/O) supervisor 216, in which the I/O supervisor 216 can manage various I/O needs through task queues. The computer host 210 additionally has multiple channels 218, connected with a plurality of I/O ports 222 of the storage controller 220. To enhance I/O performance, this example further provides a cache 224 as a temporary area for data conversion. This storage controller 220 builds multiple paths there between the processing unit 230 and the storage device 240, such that the computer host 210 can access data through the storage controller 220 as well as the paths built by the processor 230 between itself and the storage device 240. By way of the I/O management unit 216 in the aforementioned system, the computer host 210 can, via a plurality of channels, connect to the storage controller 220 formed by multiple I/O interfaces, so as to access one or more storage device.

### SUMMARY OF THE INVENTION

According to the prior art, applying multiple I/O interfaces onto communications of storage devices can provide access with higher efficiency in digital processing as an addition to communication with the system via independent I/O interfaces of each devices. Subsequently, in order to increase reliability of multiple I/O interface cards used in the storage device, the present invention further provides a multiple I/O interfacing system for a storage device and communicating method for the same, which is a highly usable connection system and method for implementing communication between processors on at least two I/O cards over the storage device, whose main purpose is to realize high reliability of communication by two or more communication paths between multiple I/O cards, whereas these communication paths may be the same interfaces, or interfaces of different types.

The preferred embodiment of multiple I/O interface system in the above-mentioned storage device utilizes two or more paths to implement communications between multiple interface cards, wherein the interface cards used in the storage device are respectively the first I/O interface card and the second I/O interface card, each has its own processing unit, connected with each other by two communication paths, and determines whether the communication path fails from the signals between the these processing units, thus generating redundancy effect, ensuring high reliability on communications between each I/O interface cards.

The preferred embodiment of the communicating method of multiple I/O interfaces for the storage device is that, first of all, the processing unit in each I/O interface card issues signals, then waits for response signals so as to determine whether the path fails; in case no failed path, then use the first path as the primary communication path; otherwise, if a path failure is detected through the response signals, then activate the redundant mechanism, and use the other path as the communication path as well as report to the system.

### BRIEF DESCRIPTION OF THE DRAWINGS

FIG. 1 is a diagram of the storage device using multiple I/O interface cards in the prior art;

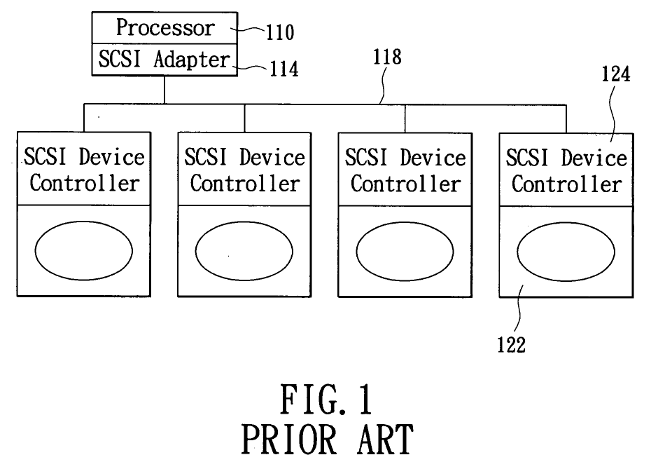

FIG. 2 is a diagram of a data process system of the storage subsystem having multiple I/O interfaces in the prior art;

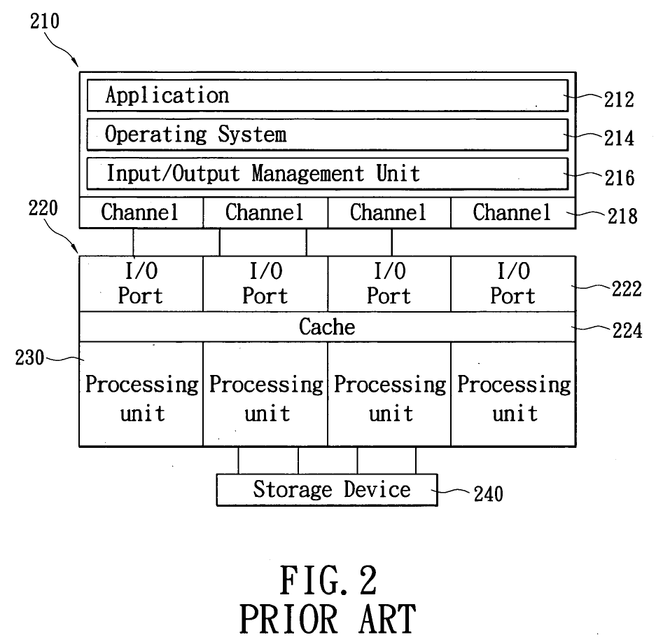

FIG. 3 shows a preferred embodiment of the multiple I/O interface system of the storage device of the present invention;

FIG. 4 shows a flowchart for the communicating method of the multiple I/O interface of the storage device of the present invention.

### DETAILED DESCRIPTION OF THE PREFERRED EMBODIMENTS

To achieve a storage device interface with high reliability, it requires not only that there provide stable communication interfaces between each storage device and the system (e.g. a computer system), but more that, in a system having multiple storage devices, each storage device is mutually linked through a specific communication format in order to create redundancy effect.

The solution proposed by the present invention is a multiple I/O interfacing system for a storage device and communicating method for the same, in particular, in a storage device of the computer system, a connection method with high reliability which implements communications between processing units on at least two input/output (I/O) interface cards. By means of communications between the processing units, it is possible to be aware of the operational status in each storage device in real-time way, including detecting the communication paths between the storage device and the system, and providing storage solution with high reliability through the redundant mechanism.

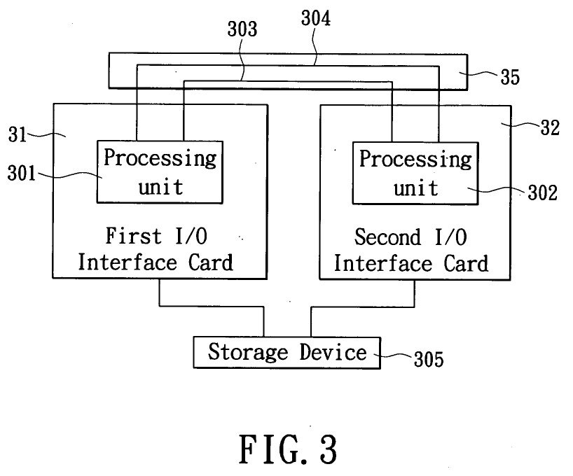

Now refer to FIG. 3, therein a preferred embodiment of multiple I/O interface system of the storage device is shown, which illustrates an implementation of two interface cards in a storage device. To ensure high reliability of communications between processing units on the two cards, the present invention uses two or more paths to implement communications between two or multiple interface cards, in which the hardware interfaces and software protocols can be based on Inter-Integrated Circuit (I²C), Universal Asynchronous Receiver/Transmitter (UART), Serial Peripheral Interface (SPI) or Serial Communication Interface (SCI). Particularly, such the architecture can be applied on implementations of more than two interface cards.

As shown in FIG. 3, two interface cards used and electrically coupled to the storage device 305 are respectively the first I/O interface card 31 and the second I/O interface card 32, each has a processing unit 301 and 302 for dealing with digital data transferred between the storage device 305 and the computer system (not shown). Two or more communication paths are built between each processing unit 301, 302 respectively provided on the I/O interface cards 31, 32, which are, in this example, communication paths 303 and 304, mutually linked and employing one or more transmission protocols. The communication paths can be realized by taking a form of one type or two types in combination, which may be linked to each I/O interface card by way of bus 35, while these links can be both of I²C or UART; or one uses I²C as the transmission protocol while the other adopts UART. The way that this embodiment uses two communication paths can effectively prevent the occurrence of communication failure in case that one of the communication paths should fail.

Essentially, the above-mentioned technical feature is that the processing units located in each I/O interface are there between mutually linked by means of I²C, UART, SPI or SCI, and communication paths linking two or more I/O interface cards may be of the same interface protocol or of different ones. Besides, the processing unit in the I/O interface cards may be based on ARM core or MIPS core, whereas not limited to such said implementations.

To achieve the effect of mutual redundancy enabled by the two or more I/O interface cards, the preferred embodiment illustrates that the communication paths between the above-mentioned each I/O interface cards use the same protocol. Under general operations, if each communication path is normal, then one of the paths connected to the computer system can be selected as the interface for the primary communication path, acting as the default I/O interface card, while the other interface card as the interface for the secondary communication path, then applied to more than two interface environments. In case one of the communication paths should fail, the other one will automatically operate for communication connection, ensuring high reliability of the communications between each I/O interface cards.

In order to realize the mutually redundant mechanism between the aforementioned interfaces, the processing units in each I/O interface cards are required to periodically detect whether the connections of communication paths are normal. In case that a communication path failure should be found, the other communication path will be used immediately; at the same time, a report will be issued to the computer host, or the system manager will be otherwise notified the current status for further process, until the communication path failure has been eliminated.

In practice, the processing units in the above-mentioned multiple I/O cards will periodically send instructions and data packets. When one of the processing units issues instructions to use the communication path between the storage device and the computer host, it works in a master mode, while the processing unit in the other I/O interface card works in a slave mode, receiving and responding signals to the processing unit which issued the instructions. As for time interval, it can range from several 10 milliseconds to several 10 seconds, based on the processing unit type and software settings used. When a communication path failure occurs, the processing unit can use the other communication interface to issue error reports to the computer host or system manager for further process. The above-described other interface in the storage device may be serial attached SCSI (SAS) or RS232 etc.

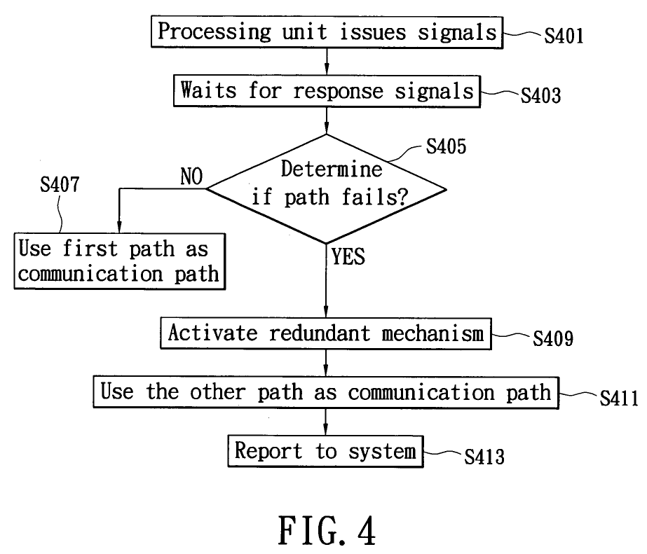

FIG. 4 shows a preferred embodiment of the communicating method for the multiple I/O interfaces of the present invention, which includes step S401, initially, the processing unit in each I/O interface card issues signals, such as broadcasting or instructions and data packets generated and directed to any specific target. Next, as step S403, the processing unit detects response signals after issuing instructions, so as to determine whether any communication paths between processing units fails (step S405); if no failed communication path detected, then it will use the first path (i.e. the primary communication path formed by the default I/O interface card between the storage device and the computer host) as the primary communication path (step S407), wherein such a default communication path is decided at the design stage of the system. Alternative embodiment may determine whether an I/O interface should be randomly or sequentially set as the primary communication path through the internal system of the computer host.

If, from the response signals, the above-mentioned default primary communication path is determined to be failed, then the present invention will activate the redundant mechanism, setting the other secondary communication path (e.g. the second path) as the communication path (step S411), and issue an error report to the system (step S413), until the communication path failure is eliminated.

The aforementioned determination about the status of communication path based on the response signals can be performed by way that if response messages can be successfully acquired between processing units; e.g. handshaking, for acknowledging the communication path conditions from the transmitted/received handshake messages; or decided in a way that whether the messages in the transmitted/received message packets are lost.

In summary, the present invention is a multiple I/O interfacing system for a storage device and communicating method for the same, which implements communications between processing units of at least two I/O cards in the storage device of a computer system, providing redundant effect between multiple I/O interface cards.

The above-mentioned descriptions represent merely the preferred embodiment of the present invention, without any intention to delineate the scope of the present invention thereto. Therefore, all equivalent changes, alternations or modifications in structure made by utilizing, or based on, the disclosed specification and appended figures of the present invention are reasonably considered to fall within the scope of the present invention.

What is claimed is:

1. A multiple input/output (I/O) interfacing system for a storage device, comprising:
two or more I/O interface cards, connected to a storage device;
two or more processing units, respectively installed in the I/O interface cards for dealing with digital data transferred between the storage device and a computer system, wherein each processing unit builds two or more communication paths between the processing units on the I/O interface cards;
wherein, one of the I/O interface cards acts as a primary interface, and one of the other I/O interface cards acts as a secondary interface, so that when one of the communication paths fails, the other communication path automatically connects and communicates, thereby the plurality of communication paths between the processing units effectively preventing the occurrence of communication failure caused by failure of one of the communication paths.

2. The multiple input/output (I/O) interfacing system for a storage device according to claim 1, wherein the communication protocol of the communication paths is I²C.

3. The multiple input/output (I/O) interfacing system for a storage device according to claim 2, wherein the communication protocol the communication paths use may be UART, SPI or SCI.

4. The multiple input/output (I/O) interfacing system for a storage device according to claim 1, wherein the two I/O interface cards are respectively a first I/O interface card and a second I/O interface card electrically connected to the storage device.

5. The multiple input/output (I/O) interfacing system for a storage device according to claim 4, wherein the processing units in the first I/O interface card and the second I/O interface card are mutually linked by means of two communication paths.

6. The multiple input/output (I/O) interfacing system for a storage device according to claim 5, wherein one of the communication paths uses I²C as the transmission protocol, the other uses UART as the transmission protocol.

7. The multiple input/output (I/O) interfacing system for a storage device according to claim 1, wherein the communication path links to each I/O interface card through a bus.

8. The multiple input/output (I/O) interfacing system for a storage device according to claim 1, wherein the I/O interface system further includes a communication interface, thereby issuing error reports.

9. The multiple input/output (I/O) interfacing system for a storage device according to claim 8, wherein the communication interface is serial attached SCSI or RS232.

10. A communicating method of multiple I/O interfaces for a storage device, comprising:
issuing signals, in which two or more processing units in the I/O interfaces, which are electrically connected to a storage device, periodically issue instructions and data packets;
detecting the response signals, determining, from the response signals, whether the communication path between each processing unit fails;
using a default I/O interface card as the primary communication path if no communication path failure is detected; or setting a secondary communication path as the communication path and issue error reports, if the default primary communication path is found to have failure.

11. The communicating method of multiple I/O interfaces for a storage device according to claim 10, wherein the communication protocol of the communication paths is I²C.

12. The communicating method of multiple I/O interfaces for a storage device according to claim 11, wherein the communication protocol the communication paths use may be UART, SPI or SCI.

13. The communicating method of multiple I/O interfaces for a storage device according to claim 10, wherein the two I/O interface cards are respectively a first I/O interface card and a second I/O interface card electrically connected to the storage device, each I/O interface card has a processing unit.

14. The communicating method of multiple I/O interfaces for a storage device according to claim 13, wherein the processing units in the first I/O interface card and the second I/O interface card are mutually linked by means of two communication paths.

15. The communicating method of multiple I/O interfaces for a storage device according to claim 14, wherein one of the communication paths uses I²C as the transmission protocol, the other uses UART as the transmission protocol.

16. The communicating method of multiple I/O interfaces for a storage device according to claim 10, wherein an I/O interface is used for issuing the error reports.

17. The communicating method of multiple I/O interfaces for a storage device according to claim 16, wherein the communication interface is a serially attached SCSI or RS232 interface.
